(19) United States
(12) Patent Application Publication
(10) Pub. No.: US 2017/0297247 A1
(43) Pub. Date: Oct. 19, 2017

(54) METHOD FOR MANUFACTURING ELONGATED BODY

(71) Applicant: TOKAI KOGYO CO., LTD., Obu-shi, Aichi (JP)

(72) Inventors: Taichi SUGAHARA, Obu-shi (JP); Hirokazu TOKUGAWA, Obu-shi (JP); Shintaro YANO, Obu-shi (JP)

(73) Assignee: TOKAI KOGYO CO., LTD., Obu-shi, Aichi (JP)

(21) Appl. No.: 15/514,099

(22) PCT Filed: Nov. 9, 2016
(86) PCT No.: PCT/JP2016/083293

§ 371 Date: Mar. 24, 2017

(30) Foreign Application Priority Data
Dec. 3, 2015 (JP) 2015-236557

(51) Int. Cl. B29C 47/00; B29C 47/02; B29L 31/30

(52) U.S. Cl. CPC B29C 47/0064; B29C 47/02; B29L 2031/30

(57) ABSTRACT

An extrusion molding process including a first tape adhering process, in which a first tape is guided to a surface of a first seal lip of an outer belt molding, which is in a heated state in a die, by a tape guide passage formed in the die of an extrusion molding machine and the first tape is adhered to the first seal lip, and a second tape adhering process, in which a second tape is guided to a surface of a second seal lip of the outer belt molding, which is in a heated state immediately after coming out from the die, by a tape guiding jig arranged adjacent to a downstream side end surface of the die of the extrusion molding machine and the second tape is adhered to the second seal lip, are performed.

### TECHNICAL FIELD

The present invention relates to a method for manufacturing an elongated body that is attached to a vehicle.

### BACKGROUND ART

Outer belt moldings and inner belt moldings that are attached to lower edges of window openings of vehicle doors, glass run channels that guide the circumferences of vehicle door windows which are moved up and down, and so on are known as examples of elongated bodies attached to vehicles.

This type of elongated bodies includes that disclosed in Patent Reference 1 (JP-A-H11-291321). According thereto, a separate extruded body supply path is formed in a die of an extrusion molding machine extrusion-molding a molding main body, and a tape-shaped member (separate extruded body in which a decorative film is joined to a surface of a molded body) supplied through the separate extruded body supply path is subjected to fusion joining to the molding main body while the molding main body is extrusion-molded.

The elongated bodies also include that disclosed in Patent Reference 2 (JP-A-H04-189134). According thereto, a hot air vulcanization device is arranged on a downstream side of an extrusion molding machine extrusion-molding a rubber base body of a glass run channel, a pressing roller is arranged on a downstream side of the hot air vulcanization device, and after the rubber base body extrusion-molded by the extrusion molding machine is heated and vulcanized by the hot air vulcanization device, a tape-shaped member (adhered member to which a laminated film is attached) is welded by the pressing roller to a surface of the rubber base body which is in a state where heat remains immediately after vulcanization.

### PRIOR ART REFERENCE

### Patent Reference

[Patent Reference 1] JP-A-H11-291321

[Patent Reference 2] JP-A-H04-189134

### SUMMARY OF INVENTION

### Technical Problem

In some cases, a plurality of tapes (such as a flocked tape and a decorative tape) need to be adhered to the elongated body such as the molding and the glass run channel attached to the vehicle. In this case, according to the technology that is disclosed in Patent Reference 1, a plurality of tape passages needs to be formed in the die of the extrusion molding machine. Depending on product shapes or the like, however, it may not be possible to ensure a space for forming the plurality of tape passages in the die of the extrusion molding machine. Further, according to the technology that is disclosed in Patent Reference 2, a plurality of combinations of heating devices heating the extrusion-molded body and the tape pressing rollers pressing the tape against the body are required to be provided on the downstream side of the extrusion molding machine, which may lead to an increase in manufacturing line size and an increase in cost.

Accordingly, an object of the present invention is to provide a method for manufacturing an elongated body by which a plurality of tapes can be adhered to the elongated body while suppressing an increase in manufacturing line size and an increase in cost.

### Means for Solving the Problems

In order to solve the above-described problem, the present invention provides a method for manufacturing an elongated body in which an attachment portion attached to a vehicle body panel of a vehicle and at least one abutting portion protruding from the attachment portion and abutting against another member are provided by being extrusion-molded by an extrusion molding machine and a tape is adhered to at least a part of the abutting portion, the method including: a first tape adhering process in which a first tape is guided to and adhered to a first tape adhering surface of the elongated body by a tape guide passage formed in a die of the extrusion molding machine; and a second tape adhering process in which a second tape is guided to and adhered to a second tape adhering surface of the elongated body by a tape guiding jig arranged adjacent to a downstream side end surface of the die of the extrusion molding machine.

In this manufacturing method, in the first tape adhering process, the first tape can be adhered to the elongated body by guiding the first tape to the surface (first tape adhering surface) of the elongated body in a heated state (semi-molten state) in the die by the tape guide passage in the die of the extrusion molding machine, and welding the first tape and the elongated body by heat of the elongated body. In the second tape adhering process, the second tape can be adhered to the elongated body by guiding the second tape to the surface (second tape adhering surface) of the elongated body in a heated state immediately after coming out from the die (uncooled state) by the tape guiding jig arranged adjacent to a downstream side of the die of the extrusion molding machine, and welding the second tape and the elongated body by the heat of the elongated body. Accordingly, the plurality of tapes can be adhered to the elongated body even in a case where a space for forming a plurality of tape guide passages cannot be ensured in the die of the extrusion molding machine. In addition, a heating device for adhering the tapes does not have to be provided on the downstream side of the extrusion molding machine, and thus, an increase in manufacturing line size and an increase in cost can be suppressed.

In this case, a tape passage into which the second tape can be inserted may be formed between the downstream side end surface of the die and the tape guiding jig. Accordingly, the second tape can be guided to the surface of the elongated body by forming the tape passage by using the tape guiding jig having a simple structure, without using a tape guiding jig that has a complex structure (such as a tape guiding jig in which a tape passage is formed).

A first abutting portion and a second abutting portion may be provided to the elongated body, in the first tape adhering process, the first tape may be adhered to a surface of the first abutting portion serving as the first tape adhering surface, and in the second tape adhering process, the second tape may be adhered to a surface of the second abutting portion serving as the second tape adhering surface. Accordingly, the tapes can be adhered well to the first abutting portion and the second abutting portion of the elongated body, respectively.

Further, the present invention may be applied to an elongated body in which the first abutting portion and the second abutting portion are provided on a same surface of the attachment portion and extend in parallel to a longitudinal direction of the elongated body so as to be arranged side by side. Even in such case where the two abutting portions are provided close to each other and thus it is difficult to ensure a space for forming two tape guide passages in the die of the extrusion molding machine, by applying the present invention, the tapes can be adhered well to the two respective abutting portions.

A decorative portion may be provided to the elongated body, in the first tape adhering process, the first tape may be adhered to a surface of the decorative portion serving as the first tape adhering surface, and in the second tape adhering process, the second tape may be adhered to a surface of the abutting portion serving as the second tape adhering surface. Accordingly, the tapes can be adhered well to the decorative portion and the abutting portion of the elongated body, respectively. In addition, the tape can be better adhered in the first tape adhering process, in which the tape is guided and adhered by the tape guide passage in the die, than in the second tape adhering process. Accordingly, the tape can be better adhered to the decorative portion by the first tape being adhered to the surface of the decorative portion in the first tape adhering process, and thus, the decorative portion can be improved in terms of appearance.

At least one of the first tape and the second tape may be a flocked tape that includes a thin film-shaped base material and innumerable fibers erected from a surface of the base material. Accordingly, wearing of a part of the elongated body to which the flocked tape is adhered (such as the abutting portion) can be reduced. In addition, even at a portion where electrostatic flocking is not possible or difficult, a low-friction layer can be formed by using the flocked tape.

### BRIEF DESCRIPTION OF DRAWINGS

FIG. 1 is a diagram illustrating a schematic configuration of a manufacturing line for an outer belt molding according to an example of the present invention.

FIG. 2 is a front view of a die of an extrusion molding machine.

FIG. 3 is a sectional view taken along line A-A of FIG. 2.

FIG. 4 is a sectional view taken along line B-B of FIG. 2.

### MODE FOR CARRYING OUT THE INVENTION

Hereinafter, a specific embodiment will be described, in which a mode for carrying out the present invention is applied to an elongated outer belt molding attached to a lower edge of a window opening of a vehicle door.

Here, an upper-lower direction and an interior-exterior direction in the description of the outer belt molding refer to a direction of gravity and a passenger compartment interior-exterior direction at a time when the outer belt molding is attached to a vehicle.

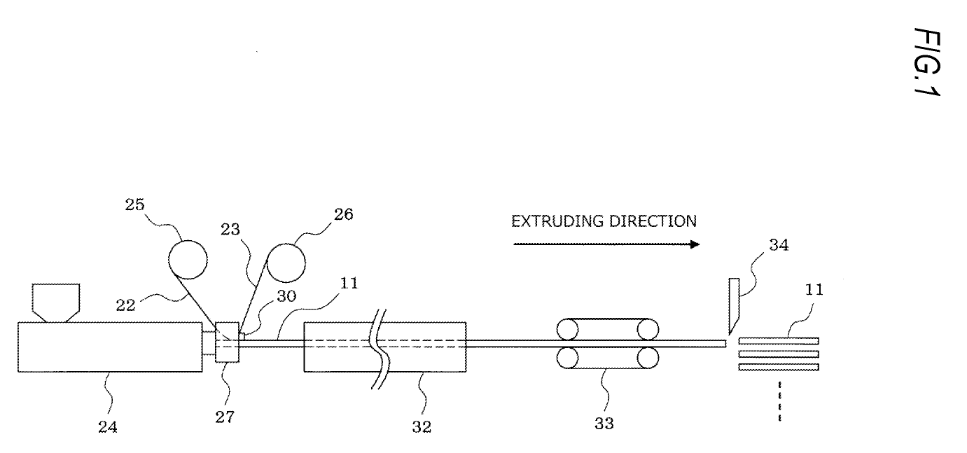

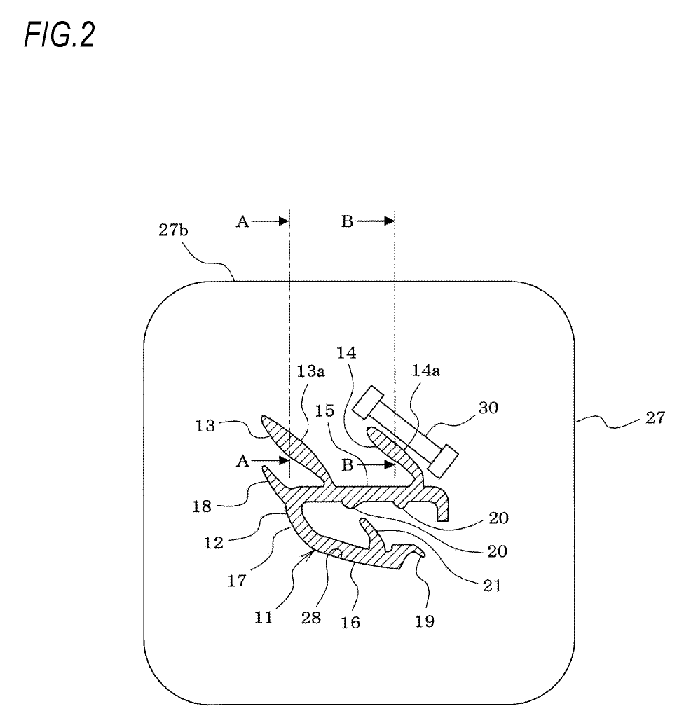

As illustrated in FIG. 2, in an outer belt molding 11 (elongated body), an attachment portion 12 that has a U-shaped cross section and is attached to a flange portion of an outer door panel (vehicle body panel) of the vehicle, and a lip-shaped first seal lip 13 (first abutting portion) and a lip-shaped second seal lip 14 (second abutting portion) that protrude from the attachment portion 12 toward an interior side (window pane side) and abut against the window pane (another member) are integrally provided by extrusion molding of a thermoplastic polymer material (such as a thermoplastic resin and a thermoplastic elastomer) by an extrusion molding machine 24 (see FIG. 1).

In the attachment portion 12, a pair of interior lateral wall 15 and exterior lateral wall 16 that face each other and a top wall 17 that connects the two lateral walls 15 and 16 are integrally provided. The first and second seal lips 13 and 14 are provided on an outside surface (that is, the same surface) of the interior lateral wall 15 of the attachment portion 12 and extend in parallel to a longitudinal direction of the outer belt molding 11 so as to be arranged side by side.

A cover lip 18, which protrudes toward the interior side, is integrally provided at an upper end of the interior lateral wall 15 (or on the top wall 17) of the attachment portion 12 and an exterior seal lip 19 is integrally provided at a lower end of the exterior lateral wall 16 of the attachment portion 12. A plurality of protruding portions 20, which protrude toward the exterior lateral wall 16, are integrally provided on an inside surface of the interior lateral wall 15 of the attachment portion 12, and a holding lip 21, which protrudes toward the interior lateral wall 15, is integrally provided on an inside surface of the exterior lateral wall 16 of the attachment portion 12. An outside part of the exterior lateral wall 16 and an outside part of the top wall 17 correspond to decorative portions.

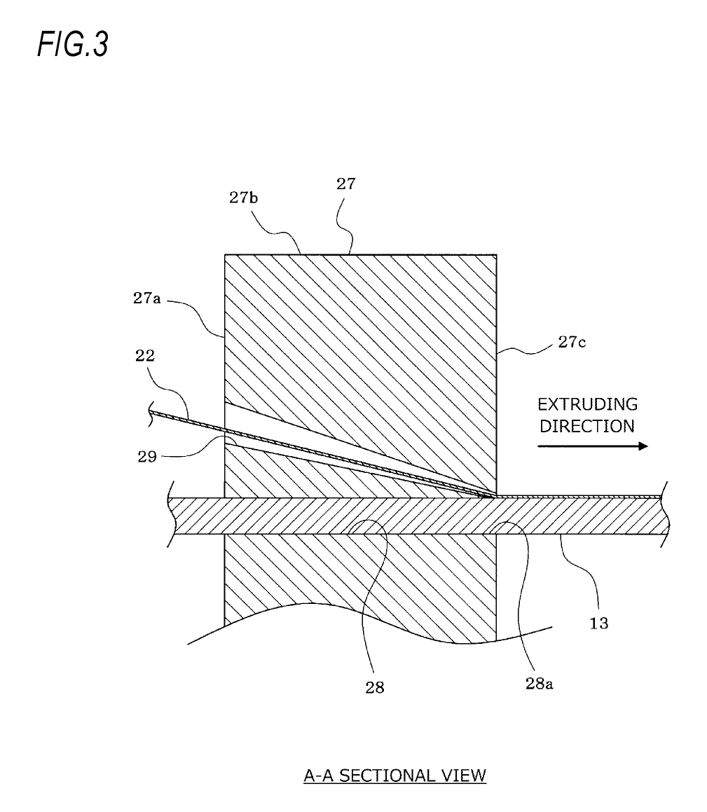

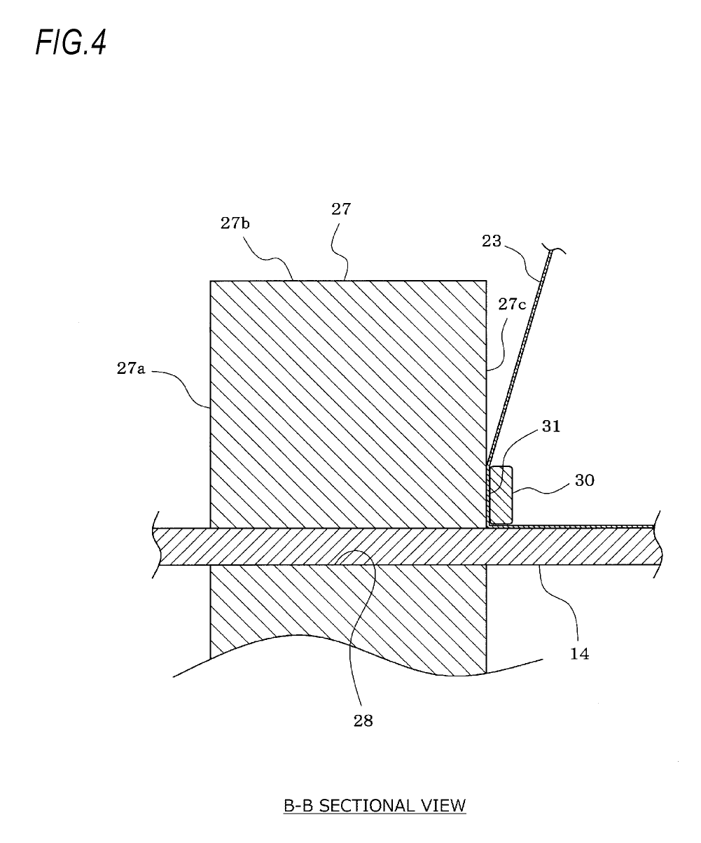

A first tape 22 (see FIG. 3) is adhered to at least a surface 13a of the first seal lip 13 which abuts against the window pane. A second tape 23 (see FIG. 4) is adhered to at least a surface 14a of the second seal lip 14 that abuts against the window pane. The tapes 22 and 23 are not illustrated in FIG. 2. The part of the surface of the first seal lip 13 to which the first tape 22 is adhered corresponds to a first tape adhering surface and the part of the surface of the second seal lip 14 to which the second tape 23 is adhered corresponds to a second tape adhering surface.

In the present embodiment, a flocked tape that includes a thin film-shaped base material and innumerable fibers erected from a surface of the base material is used as the first and second tapes 22 and 23. A low-friction layer can be formed from the flocked tape. The same type of flocked tapes may be used as the first tape 22 and the second tape 23. Different types of flocked tapes may be used as the first tape 22 and the second tape 23 as well.

In the outer belt molding 11, when the attachment portion 12 is mounted on and covers the flange portion of the outer door panel, the first and second seal lips 13 and 14 abut against a surface of the window pane. As a result, the outer belt molding 11 provides sealing between the outer door panel and the window pane by means of the seal lips 13 and 14 and prevents foreign matter (such as dust, dirt, and water drops) from entering the vehicle from the exterior side. In addition, foreign matter sticked to the surface of the window pane is wiped off by the seal lips 13 and 14 during up and down movements (opening and closing movements) of the window pane. In the present embodiment, the seal lips 13 and 14 come in close contact with the window pane with ease since the seal lips 13 and 14 have the lip shapes, and an excellent wiping performance and excellent sound insulation are achieved since two seal lips 13 and 14 are provided.

Hereinafter, an apparatus and a method for manufacturing the outer belt molding 11 will be described with reference to FIGS. 1 to 4.

As illustrated in FIG. 1, a first uncoiler 25 on which the first tape 22 is wound and a second uncoiler 26 on which the second tape 23 is wound are arranged near the extrusion molding machine 24. In the present embodiment, the first uncoiler 25 is arranged upstream of a die 27 (mold) of the extrusion molding machine 24 and the second uncoiler 26 is arranged downstream of the die 27 of the extrusion molding machine 24. As illustrated in FIGS. 2 to 4, an extrusion flow path 28, which has a sectional shape corresponding to the outer belt molding 11, is formed in the die 27 of the extrusion molding machine 24 to extend from an upstream side to a downstream side.

In a case where the outer belt molding 11 is manufactured, first of all, an extrusion molding process in which a main body portion of the outer belt molding 11 (parts other than the tapes 22 and 23 such as the attachment portion 12 and the seal lips 13 and 14) is extrusion-molded is executed by the extrusion molding machine 24. A first tape adhering process and a second tape adhering process are executed at this time. The first tape adhering process is a process in which the first tape 22 sent out from the first uncoiler 25 is adhered to the surface of the first seal lip 13 (first tape adhering surface) and the second tape adhering process is a process in which the second tape 23 sent out from the second uncoiler 26 is adhered to the surface (second tape adhering surface) of the second seal lip 14.

Preferably, the attachment portion 12 as a part of the main body portion of the outer belt molding 11 is formed by using a rigid and hard material and the parts that abut against a member other than the outer belt molding 11, such as the seal lips 13 and 14, are formed by using a material which is softer than the material forming the attachment portion 12.

A tape guide passage 29 is formed in the die 27 of the extrusion molding machine 24 as illustrated in FIG. 3 and the tape guide passage 29 guides the first tape 22 to the surface of the first seal lip 13. The tape guide passage 29 is formed such that it extends downstream from an upstream side end surface 27a (or an upper side end surface 27b) of the die 27 and communicates with the part of the extrusion flow path 28 that corresponds to the surface of the first seal lip 13 (first tape adhering surface) near a downstream side opening portion 28a of the extrusion flow path 28. As a result, the first tape 22 sent out from the first uncoiler 25 is guided to the surface of the first seal lip 13 through the tape guide passage 29. After being guided to the surface of the first seal lip 13, the first tape 22 is pressure-welded to the surface of the first seal lip 13 by an inner wall surface of the tape guide passage 29 and an inner wall surface of the extrusion flow path 28.

In the first tape adhering process, the first tape 22 is adhered to the first seal lip 13 by guiding the first tape 22 to the surface of the first seal lip 13 (first tape adhering surface), which is in a heated state in the die 27, by the tape guide passage 29 in the die 27 of the extrusion molding machine 24, and welding the first tape 22 and the first seal lip 13 by heat of the first seal lip 13. The inner wall surface of the tape guide passage 29 and the inner wall surface of the extrusion flow path 28 are formed in a curved surface shape that corresponds to a curved surface shape of the surface of the first seal lip 13 (including a curved surface shape of a tip portion of the first seal lip 13 in a case where the first tape 22 is adhered even to the tip portion of the first seal lip 13). As a result, the first tape 22 can be adhered well along the curved surface shape of the surface of the first seal lip 13.

A tape guiding jig 30, which guides the second tape 23 to the surface of the second seal lip 14 (second tape adhering surface), is arranged on a downstream side of the die 27 of the extrusion molding machine 24 and is adjacent to a downstream side end surface 27c of the die 27 as illustrated in FIGS. 2 and 4. A tape passage 31 into which the second tape 23 can be inserted is formed between the tape guiding jig 30 and the downstream side end surface 27c of the die 27. Accordingly, the second tape 23 sent out from the second uncoiler 26 is folded in a direction along the surface of the second seal lip 14 by the tape guiding jig 30 after passing through the tape passage 31 and is guided to the surface of the second seal lip 14. After being guided to the surface of the second seal lip 14, the second tape 23 is pressure-welded to the surface of the second seal lip 14 by a lower end surface of the tape guiding jig 30.

In the second tape adhering process, the second tape 23 is adhered to the second seal lip 14 by guiding the second tape 23 to the surface of the second seal lip 14 (second tape adhering surface), which is in a heated state immediately after coming out of the die 27, by the tape guiding jig 30 arranged adjacent to the downstream side of the die 27 of the extrusion molding machine 24, and welding the second tape 23 and the second seal lip 14 by heat of the second seal lip 14. Preferably, the lower end surface of the tape guiding jig 30 is formed in a curved surface shape that corresponds to a curved surface shape of the surface of the second seal lip 14 (including a curved surface shape of a tip portion of the second seal lip 14 in a case where the second tape 23 is adhered even to the tip portion of the second seal lip 14). As a result, the second tape 23 can be adhered well along the curved surface shape of the surface of the second seal lip 14.

Subsequently, the outer belt molding 11 extruded from the extrusion molding machine 24 (outer belt molding 11 to which the first and second tapes 22 and 23 are adhered) is supplied to a cooling machine 32 having a cooling water bath therein while being taken off by a hauling machine 33 as illustrated in FIG. 1. The outer belt molding 11 is cooled by the cooling machine 32.

Then, the outer belt molding 11 is supplied to a cutting machine 34 and the outer belt molding 11 is cut by the cutting machine 34 into a predetermined length. Then, the manufacturing of the outer belt molding 11 is completed through finishing processes such as partial terminal end cutting and attachment tool (clip) mounting.

In the present embodiment described above, in the first tape adhering process, the first tape 22 can be guided to and adhered to the surface of the first seal lip 13 (first tape adhering surface) in the heated state in the die 27 by the tape guide passage 29 in the die 27 of the extrusion molding machine 24, and in the second tape adhering process, the second tape 23 can be guided and adhered to the surface (second tape adhering surface) of the second seal lip 14 in the heated state immediately after coming out from the die 27 by the tape guiding jig 30 arranged adjacent to the downstream side of the die 27 of the extrusion molding machine 24. Accordingly, the plurality of tapes 22 and 23 can be adhered to the outer belt molding 11 even in a case where a space for forming a plurality of tape guide passages cannot be ensured in the die 27 of the extrusion molding machine 24. In addition, a heating device for adhering the tapes 22 and 23 does not have to be provided on the downstream side of the extrusion molding machine 24, and thus, an increase in manufacturing line size and an increase in cost can be suppressed.

In the present embodiment, the tape passage 31 into which the second tape 23 can be inserted is formed between the downstream side end surface 27c of the die 27 and the tape guiding jig 30. Accordingly, the second tape 23 can be guided to the surface of the second seal lip 14 by forming the tape passage 31 by using the tape guiding jig 30 having a simple structure, without using a tape guiding jig that has a complex structure (such as a tape guiding jig in which a tape passage is formed).

In the present embodiment, the first tape 22 is adhered to the surface of the first seal lip 13 in the first tape adhering process and the second tape 23 is adhered to the surface of the second seal lip 14 in the second tape adhering process. Accordingly, the tapes 22 and 23 can be adhered well to the two seal lips 13 and 14 of the outer belt molding 11, respectively. Further, in the first tape adhering process in which the tape 22 is guided and adhered by the tape guide passage 29 in the die 27, the tape 22 can be adhered with a higher level of stability than in the second tape adhering process at a portion that has a curved surface in particular. Accordingly, the tape 22 can be better adhered to the first seal lip 13 by the tape 22 being adhered to the surface of the first seal lip 13 in the first tape adhering process, and thus, the first seal lip 13 (that is, the seal lip positioned above the second seal lip 14 and more noticed by people than the second seal lip 14 when the outer belt molding 11 is attached to the vehicle) can be improved in terms of appearance.

In the present embodiment, the first seal lip 13 and the second seal lip 14 are provided on the same surface of the attachment portion 12 and extend in parallel to the longitudinal direction of the outer belt molding 11 so as to be arranged side by side. Even in such case where the two seal lips 13 and 14 are provided close to each other and thus it is difficult to ensure a space for forming two tape guide passages in the die 27 of the extrusion molding machine 24, by applying the manufacturing method according to the present embodiment, the tapes 22 and 23 can be adhered well to the two respective seal lips 13 and 14.

In the present embodiment, the flocked tape is used as the tapes 22 and 23 adhered to the seal lips 13 and 14. Accordingly, wearing of the seal lips 13 and 14 can be reduced with the low-friction layers formed on the surfaces of the seal lips 13 and 14. In addition, even at a portion where electrostatic flocking is not possible or difficult, a low-friction layer can be formed by using the flocked tape.

Here, in the embodiment described above, the tape passage 31 into which the second tape 23 can be inserted is formed between the downstream side end surface 27c of the die 27 and the tape guiding jig 30. However, the present invention is not limited thereto. For example, a tape passage into which the second tape can be inserted may be formed inside the tape guiding jig.

In the example described above, the present invention is applied to the outer belt molding in which the lip-shaped abutting portions (seal lips) are provided as the first and second abutting portions. However, the present invention may also be applied to an outer belt molding in which abutting portions that have a stabilizer shape such as a mountain shape and a semicircular shape are provided as the first and second abutting portions or an outer belt molding in which one of the first and second abutting portions has a lip shape and the other one of the first and second abutting portions has a stabilizer shape.

The portions where the first and second tapes are adhered and the types of the first and second tapes are not limited to the range described above in the embodiment and may be appropriately changed. Examples of the type of the tapes other than the flocked tape include a decorative tape, a transfer tape, and a protective tape. The decorative tape is a tape providing a color tone and a texture (metallic tone, lacquer tone, painting tone, and so on) that differ from those of other portions. The transfer tape is attached to make the surface of the elongated body (molded article) to be smooth and is peeled off after the elongated body is molded or when the elongated body is used. The protective tape is attached for protection of the surface of the elongated body (molded article) and is peeled off when the elongated body is used. The first tape and the second tape may be of the same type. The first tape and the second tape may be of different types as well.

For example, the decorative tape may be adhered as the first tape to the surface of the decorative portion (such as the outside part of the exterior lateral wall and the outside part of the top wall) in the first tape adhering process and the flocked tape may be adhered as the second tape to the surface of the abutting portion (such as the first seal lip) in the second tape adhering process. As a result, the respective tapes can be adhered well to the decorative portion and the abutting portion. In addition, the tape can be better adhered in the first tape adhering process than in the second tape adhering process. Accordingly, the tape can be better adhered to the decorative portion by the first tape (decorative tape) being adhered to the surface of the decorative portion in the first tape adhering process, and thus the decorative portion can be improved in terms of appearance.

Although the present invention is applied to the outer belt molding in the embodiment described above, the present invention is not limited thereto. The present invention can also be carried out based on application to various types of elongated bodies which are extrusion-molded and have a tape adhered to at least a part of its abutting portion. For example, the present invention can be applied to inner belt moldings, glass run channels, window moldings, and the like.

### REFERENCE SIGNS LIST

11 Outer belt molding (elongated body)
12 Attachment portion
13 First seal lip (first abutting portion)
14 Second seal lip (second abutting portion)
22 First tape
23 Second tape
24 Extrusion molding machine
27 Die
29 Tape guide passage
30 Tape guiding jig
31 Tape passage

1. A method for manufacturing an elongated body in which an attachment portion attached to a vehicle body panel of a vehicle and at least one abutting portion protruding from the attachment portion and abutting against another member are provided by being extrusion-molded by an extrusion molding machine and a tape is adhered to at least a part of the abutting portion, the method comprising:
a first tape adhering process in which a first tape is guided to and adhered to a first tape adhering surface of the elongated body by a tape guide passage formed in a die of the extrusion molding machine; and
a second tape adhering process in which a second tape is guided to and adhered to a second tape adhering surface of the elongated body by a tape guiding jig arranged adjacent to a downstream side end surface of the die of the extrusion molding machine.

2. The method for manufacturing the elongated body according to claim 1,
wherein a tape passage into which the second tape can be inserted is formed between the downstream side end surface of the die and the tape guiding jig.

3. The method for manufacturing the elongated body according to claim 1,
wherein a first abutting portion and a second abutting portion are provided to the elongated body,
wherein, in the first tape adhering process, the first tape is adhered to a surface of the first abutting portion serving as the first tape adhering surface, and
wherein, in the second tape adhering process, the second tape is adhered to a surface of the second abutting portion serving as the second tape adhering surface.

4. The method for manufacturing the elongated body according to claim 3,
wherein the first abutting portion and the second abutting portion are provided on a same surface of the attachment portion and extend in parallel to a longitudinal direction of the elongated body so as to be arranged side by side.

5. The method for manufacturing the elongated body according to claim 1,
wherein a decorative portion is provided to the elongated body,
wherein, in the first tape adhering process, the first tape is adhered to a surface of the decorative portion serving as the first tape adhering surface, and
wherein, in the second tape adhering process, the second tape is adhered to a surface of the abutting portion serving as the second tape adhering surface.

6. The method for manufacturing the elongated body according to claim 1,
wherein at least one of the first tape and the second tape is a flocked tape that includes a thin film-shaped base material and innumerable fibers erected from a surface of the base material.
